(19) United States
(12) Patent Application Publication
(10) Pub. No.: US 2026/0171095 A1
(43) Pub. Date: Jun. 18, 2026

(54) CLONED VOICE DETECTION

(71) Applicant: Transaction Network Services, Inc., Reston, VA (US)

(72) Inventors: Ananth Nagaraja Iyer, Carmel, IN (US); Yuxiao Huang, McLean, VA (US)

(21) Appl. No.: 19/416,798

(22) Filed: Dec. 11, 2025

Related U.S. Application Data
(60) Provisional application No. 63/733,035, filed on Dec. 12, 2024.

(51) Int. Cl. G10L 17/18; G06F 21/32; G10L 17/04

(52) U.S. Cl. CPC G10L 17/18; G06F 21/32; G10L 17/04

(57) ABSTRACT

Disclosed are various embodiments for performing cloned voice detection. In one embodiment, an audio sample of a voice is received. It is determined whether the voice in the audio sample is an authentic voice or a cloned voice using a machine learning model trained to recognize cloned voices. An action is implemented in response to determining that the voice is the cloned voice. Examples of such actions may include causing a graphical user interface on a phone device to render a notification indicating detection of the cloned voice, returning an indication via an application programming interface that the voice is determined to be cloned, or denying a request to access a secured resource using the voice as an authentication factor.

### BACKGROUND

Text-to-Speech (TTS) technology refers to systems that convert written text into spoken words. These systems have evolved significantly over the past few decades, leveraging advancements in artificial intelligence, machine learning, and natural language processing (NLP). TTS tools are widely used in various applications, from accessibility solutions for visually impaired individuals to virtual assistants, automotive systems, and educational tools.

Early TTS systems were rule-based, relying on predefined phonetic rules to synthesize speech. These early systems, though functional, often produced robotic and unnatural-sounding speech due to their reliance on simple concatenation methods and limited speech databases. As technology advanced, data-driven techniques using large-scale voice recordings and statistical models significantly improved speech quality and fluency. The development of more sophisticated algorithms, such as Hidden Markov Models (HMM) and unit selection synthesis, allowed TTS systems to generate more natural and expressive speech, though challenges with tone, rhythm, and pronunciation remained.

In recent years, deep learning techniques, particularly neural networks, have revolutionized TTS systems. Deep neural network (DNN)-based models enable high-quality speech synthesis with natural intonation, pacing, and inflection. These systems can better capture the nuances of human speech, producing voices that are nearly indistinguishable from real human speakers. Furthermore, these models can be trained to replicate different accents, emotions, and speaking styles, making TTS technology adaptable to various use cases and user preferences.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a schematic block diagram of a networked environment according to various embodiments of the present disclosure.

FIG. 2 is a flowchart illustrating an example of functionality implemented as portions of a voice cloning detection service executed in a computing environment in the networked environment of FIG. 1 according to various embodiments of the present disclosure.

FIGS. 3-5 are flowcharts illustrating examples of functionality implemented as portions of a voice cloning detection training service executed in a computing environment in the networked environment of FIG. 1 according to various embodiments of the present disclosure.

FIG. 6 is a flowchart illustrating an example of functionality implemented as portions of an authentication service executed in a computing environment in the networked environment of FIG. 1 according to various embodiments of the present disclosure.

FIG. 7 is a schematic block diagram that provides one example illustration of a computing environment employed in the networked environment of FIG. 1 according to various embodiments of the present disclosure.

### DETAILED DESCRIPTION

The present disclosure generally relates to approaches for detecting cloned voices. Text-to-speech tools have advanced tremendously in recent years, including the ability to mimic or clone a particular speaker's voice. For example, someone may upload a sample of a person's voice. The tool can analyze the sample and synthesize speech that embodies the person's distinctive vocal characteristics. In some cases, tools are able to generate cloned voices based on a sample as short as three to ten seconds in length.

While voice cloning technology can have beneficial uses (e.g., replicating voices for people with speech disorders), unfortunately there are many nefarious uses. Bad actors can potentially clone a voice from a sample as short as a prerecorded voicemail greeting. Because the human brain is adept at compensating for missing information, even a poor replication of a voice may be incorrectly recognized as legitimate if it embodies a few distinguishing characteristics of the authentic voice. Bad actors can leverage this technology to bypass security based on voice recognition or to defraud people. For example, a common scam is for a malicious actor to clone a voice of a person and then call a friend or relative of that person, asking for funds to be sent to help bail the person out of jail. Too often, the friend or relative believes the scam on the basis of recognizing the voice, and funds are sent to the malicious actor.

Various embodiments of the present disclosure introduce approaches for recognizing and identifying audio samples of cloned voices. A machine learning model is trained based upon both an original audio sample of a person's voice and a cloned audio sample generated by a voice cloning tool from the original audio sample. In this way, the machine learning model can recognize the differences from an original recording of an authentic voice, and a computer-generated cloned voice sample. Telephone calls may be flagged if audio from the caller is recognized to be potentially cloned voice. In some embodiments, cloned voice detection may be extended to a video conferencing context to also detect cloned video content created by generative artificial intelligence (AI).

As one skilled in the art will appreciate in light of this disclosure, certain embodiments may be capable of achieving certain advantages, including some or all of the following: (1) improving the functioning of computer systems by automatically detecting a cloned voice in a sample, thereby recognizing situations in which a cloned voice is unexpected or improperly used; (2) improving the security of computer systems that employ voice recognition as a security credential by disallowing access to secured resources based on cloned voice detection; (3) improving the functioning of telephone networks and video conferencing applications by automatically flagging cloned voice or video to a recipient, thereby providing the recipient additional information in judging how to respond to the voice and/or video; and so forth. In the following discussion, a general description of the system and its components is provided, followed by a discussion of the operation of the same.

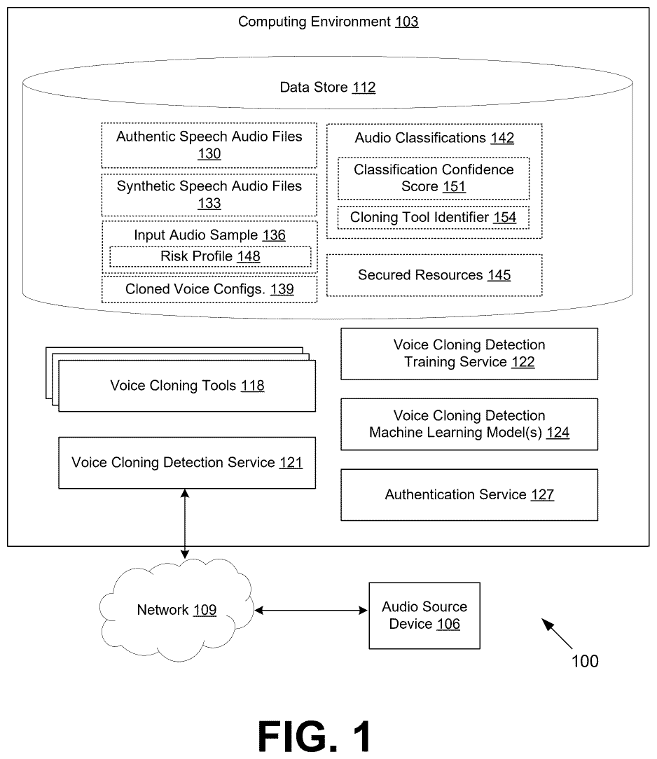

With reference to FIG. 1, shown is a networked environment 100 according to various embodiments. The networked environment 100 includes a computing environment 103 and an audio source device 106, which are in data communication with each other via a network 109. The network 109 includes, for example, the public switched telephone network (PSTN), the Internet, intranets, extranets, wide area networks (WANs), local area networks (LANs), wired networks, wireless networks, cable networks, satellite networks, or other suitable networks, etc., or any combination of two or more such networks.

The computing environment 103 may comprise, for example, a server computer or any other system providing computing capability. Alternatively, the computing environment 103 may employ a plurality of computing devices that may be arranged, for example, in one or more server banks or computer banks or other arrangements. Such computing devices may be located in a single installation or may be distributed among many different geographical locations. For example, the computing environment 103 may include a plurality of computing devices that together may comprise a hosted computing resource, a grid computing resource, and/or any other distributed computing arrangement. In some cases, the computing environment 103 may correspond to an elastic computing resource where the allotted capacity of processing, network, storage, or other computing-related resources may vary over time.

Various applications and/or other functionality may be executed in the computing environment 103 according to various embodiments. Also, various data is stored in a data store 112 that is accessible to the computing environment 103. The data store 112 may be representative of a plurality of data stores 112 as can be appreciated. The data stored in the data store 112, for example, is associated with the operation of the various applications and/or functional entities described below.

The components executed on the computing environment 103, for example, include one or more voice cloning tools 118, a voice cloning detection service 121, a voice cloning detection training service 122, one or more voice cloning detection machine learning (ML) models 124, an authentication service 127, and other applications, services, processes, systems, engines, or functionality not discussed in detail herein.

A voice cloning tool 118 uses advanced artificial intelligence (AI) techniques, particularly deep learning and neural networks, to replicate a person's voice with a high degree of accuracy. Voice cloning tools 118 electronically generate speech based on identified characteristics of a voice represented in reference samples. Voice cloning tools 118 analyze recordings of a speaker's voice to capture their unique vocal characteristics, such as tone, pitch, accent, and intonation, and generate new speech that sounds like the original speaker. Voice cloning tools 118 may provide a text-to-speech engine in order to generate audio containing synthetic speech using the cloned voices. Non-limiting examples of commercially available voice cloning tools 118 include RESEMBLE AI, ISPEECH, PLAYHT, and DESCRIPT. In some cases, the voice cloning tool 118 may be implemented as a network service hosted by a third-party provider that exposes an application programming interface (API) allowing the service to be called over the network 109.

The computing environment 103 may be configured to access multiple voice cloning tools 118 in order to accurately detect voice cloning generated by any one of the voice cloning tools 118. This is because each voice cloning tool 118 may generate synthetic speech in a unique way compared to other voice cloning tools 118. Accordingly, it is important to be able to recognize cloned voices as generated by any of the voice cloning tools 118 in making a determination whether input audio includes a cloned voice.

The voice cloning detection service 121 is executed to classify input audio as either including cloned voice or not including cloned voice. For example, the voice cloning detection service 121 may process audio captured via a telephone call to determine whether the caller is using cloned voice. The voice cloning detection training service 122 is executed to train the voice cloning detection ML models 124 to recognize cloned voice. For example, the voice cloning detection training service 122 may receive authentic speech, generate synthetic speech using a voice cloning tool 118 from the authentic speech, and then compare the authentic speech with the synthetic speech to identify differences that signal the presence of voice cloning.

A voice cloning detection ML model 124 may be trained for each one of the voice cloning tools 118 to recognize synthetic speech generated using the particular voice cloning tool 118. In some embodiments, the voice cloning detection ML models 124 may use neural network transformer models to analyze and process voice data. The voice cloning detection training service 122 may also update the voice cloning detection ML models 124 over time by continuously training based at least in part on audio data analyzed by the voice cloning detection training service 122 and confirmations or rejections of such classifications. Accordingly, the neural network may continuously learn and adapt from new data, improving its detection capabilities over time and staying ahead of evolving cloning technologies. In some embodiments, the voice cloning detection ML model 124 may have its architecture specially adapted to a voice authentication detection task. Then, the specially adapted voice cloning detection ML model 124 may be trained on audio data analyzed by the voice cloning detection training service 122.

The authentication service 127 may be executed to authenticate the audio source device 106 or other devices for access to secured resources. A user may be requested to provide one or more authentication factors, such as passwords, tokens, one-time codes, fingerprints, voice samples, answers to knowledge-based questions, and so on. In particular, authentication factors based on voice profiling using voice samples may be susceptible to attacks using cloned voices. In order to prevent such an attack, the authentication service 127 may employ the voice cloning detection service 121 to analyze a voice sample in order to determine whether it contains cloned voice. In such cases, the authentication service 127 may fail an authentication request, thereby denying access to secured resources. Alternatively, the authentication service 127 may require the user to provide one or more additional authentication factors. In some cases, the authentication service 127 may be operated by a different entity than the voice cloning detection service 121, where the voice cloning detection service 121 may be called by third parties via an API.

The data stored in the data store 112 may include, for example, one or more authentic speech audio files 130, one or more synthetic speech audio files 133, one or more input audio samples 136, one or more cloned voice configurations 139, one or more audio classifications 142, one or more secured resources 145, and/or other data. The authentic speech audio files 130 correspond to audio samples of authentic speech that is captured for training purposes. The authentic speech audio files 130 may correspond to the speech of multiple people, potentially with variations in gender, regional accents, etc. The people may be each be stating the same words in some examples, or they may be stating different words in other examples.

The synthetic speech audio files 133 correspond to audio generated by the voice cloning tools 118 based on the authentic speech audio files 130. Specifically, the synthetic speech audio files 133 may be generated based on a cloned voice determined from the authentic speech audio files 130. The synthetic speech audio files 133 may be generated with the same words or speech as the authentic speech audio files 130, or the synthetic speech audio files 133 may be generated using different words or speech. In some cases, multiple synthetic speech audio files 133 may be generated for one authentic speech audio file 130. Further, synthetic speech audio files 133 may be generated for each one of a plurality of different voice cloning tools 118.

The input audio sample 136 may correspond to an audio sample to be analyzed by the voice cloning detection service 121 to determine whether the input audio sample 136 includes cloned speech. The input audio sample 136 may be provided over the network 109 by the audio source device 106. In one scenario, the input audio sample 136 is captured by the audio source device 106 from an ongoing telephone call. In another scenario, the input audio sample 136 is pre-recorded audio uploaded at a later time for analysis.

The input audio sample 136 may be associated with a corresponding risk profile 148 identifying risk attributes. For example, the speech content of the input audio sample 136 may be analyzed and determined to be potentially fraudulent based on the speaker's intent. Risk may also be determined based upon a geographic location originating the audio, or on other factors. If the risk profile 148 is indicative of a high risk or a bad intent, the voice cloning detection service 121 may be more likely to conclude that voice cloning is used. Alternatively, a lower confidence level may be employed to conclude that voice cloning is used.

The cloned voice configurations 139 may correspond to specific voices generated by the voice cloning tools 118. The voice cloning tools 118 may employ text-to-speech using the cloned voice configuration 139 to generate speech using a cloned voice. The cloned voice configurations 139 may be used multiple times to generate multiple synthetic speech audio files 133. The cloned voice configurations 139 may also be regenerated over time based on updates to the voice cloning tools 118.

The audio classifications 142 indicate whether the input audio sample 136 is determined by the voice cloning detection service 121 to include cloned voice or not. The audio classification 142 may be associated with a classification confidence score 151, indicating the strength of the determination or likelihood that the determination is correct. For example, the classification confidence score 151 may indicate that a specific input audio sample 136 is determined to include cloned voice with a confidence level of 99%. In another example, the classification confidence score 151 may indicate that a specific input audio sample 136 is determined not to include cloned voice with a confidence level of 70%.

The cloning tool identifier 154 may identify a likely voice cloning tool 118 that was used in generating at least a portion of the input audio sample 136. In some scenarios, multiple potential voice cloning tools 118 may be identified, with different respective confidence levels. For example, a first tool may be 40 percent likely, and a second tool may be 60 percent likely.

The secured resources 145 may correspond to data or services associated with permissions that limit access to authenticated users. The authentication service 127 may perform authentication of users/devices in order to access the secured resources 145.

The audio source device 106 may transmit the input audio sample 136 to the voice cloning detection service 121 for analysis. In one scenario, the audio source device 106 may be a smartphone capturing the audio from an ongoing call, and sending the audio to the voice cloning detection service 121. In another scenario, the audio source device 106 may correspond to a telephone network function that replicates the audio data from an ongoing call to the voice cloning detection service 121. For example, in the context of cellular networks, the audio source device 106 may correspond to a user plane function (UPF). The audio source device 106 may capture or obtain the input audio sample 136 in myriad other ways.

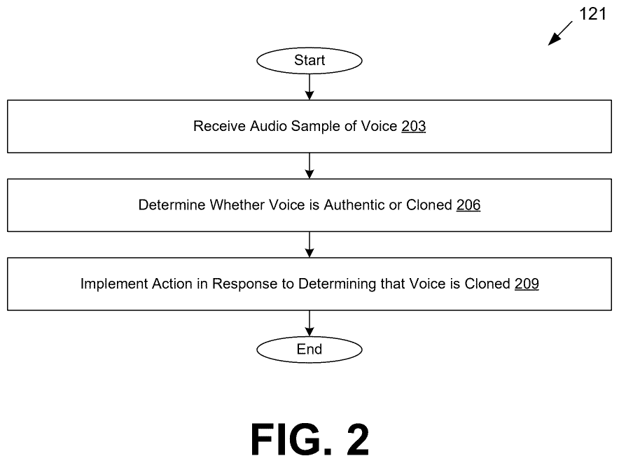

Referring next to FIG. 2, shown is a flowchart that provides one example of the operation of a portion of the voice cloning detection service 121 according to various embodiments. It is understood that the flowchart of FIG. 2 provides merely an example of the many different types of functional arrangements that may be employed to implement the operation of the portion of the voice cloning detection service 121 as described herein. As an alternative, the flowchart of FIG. 2 may be viewed as depicting an example of elements of a method implemented in the computing environment 103 (FIG. 1) according to one or more embodiments.

Beginning with box 203, the voice cloning detection service 121 receives an input audio sample 136 of a voice. For example, the audio source device 106 may upload the input audio sample 136 to the voice cloning detection service 121. In one scenario, the input audio sample 136 is audio captured from an on-going phone call. In various embodiments, a risk profile 148 associated with the input audio sample 136 may be determined.

In box 206, the voice cloning detection service 121 determines whether the voice in the input audio sample 136 is authentic or is cloned by analyzing the input audio sample 136. For example, the voice cloning detection service 121 may employ the voice cloning detection ML models 124 to generate an audio classification 142. The audio classification 142 may be associated with a classification confidence score 151. In some cases, the voice cloning detection service 121 determines that the input audio sample 136 contains cloned voice only if the classification confidence score 151 meets or exceeds a threshold value. In some scenarios, the threshold value may be based at least in part on attributes of the risk profile 148 associated with the input audio sample 136. That is, if the risk profile 148 indicates a greater likelihood that the input audio sample 136 represents fraudulent or malicious intent, a lower threshold for the classification confidence score 151 may be required in order to classify the input audio sample 136 as being cloned. In some cases, a speech-to-text tool may be used to generate textual speech content from the audio, and an analysis of the speech content may be a factor in the risk profile. For example, the speech content may correspond to typical scripts from malicious callers.

In box 209, the voice cloning detection service 121 implements one or more actions, or causes one or more actions to be implemented, in response to determining that the voice represented in the input audio sample 136 is cloned. In one example, the voice cloning detection service 121 may return via an API that the voice is determined to be cloned or authentic. In another example, the voice cloning detection service 121 may cause a warning to be rendered via the audio source device 106 (e.g., a visual notification on a graphical user interface, an audio notification via a speaker, etc.) that an on-going call includes cloned voice. Thereafter, the operation of the portion of the voice cloning detection service 121 ends.

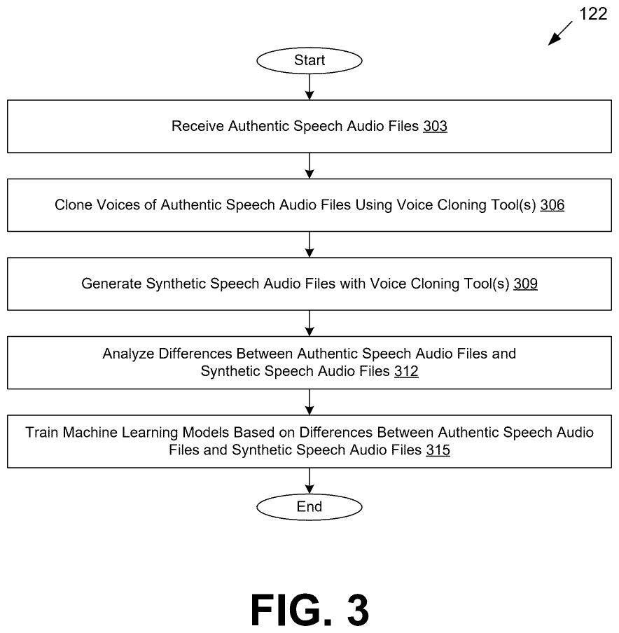

Turning now to FIG. 3, shown is a flowchart that provides one example of the operation of a portion of the voice cloning detection training service 122 according to various embodiments. It is understood that the flowchart of FIG. 3 provides merely an example of the many different types of functional arrangements that may be employed to implement the operation of the portion of the voice cloning detection training service 122 as described herein. As an alternative, the flowchart of FIG. 3 may be viewed as depicting an example of elements of a method implemented in the computing environment 103 (FIG. 1) according to one or more embodiments.

Beginning with box 303, the voice cloning detection training service 122 receives authentic speech audio files 130 that correspond to samples of authentic speech by human speakers. The authentic speech audio files 130 may correspond to a variety of voices diverse on gender, regional accents, age, and other characteristics. The authentic speech audio files 130 may be uncompressed pulse code modulation (PCM) waveform files, or may be compressed using techniques such as the μ-law algorithm, Moving Picture Experts Group Phase 1 (MPEG-1) Layer 3(MP3 ), OGG VORBIS, Advance Audio Coding (AAC), and others.

In box 306, the voice cloning detection training service 122 clones the voices represented in the authentic speech audio files 130 using one or more voice cloning tools 118, thereby generating one or more cloned voice configurations 139. In some cases, multiple voice cloning tools 118 may be used for each of the authentic speech audio files 130 to generate multiple instances of the cloned voice configurations 139. The voice cloning tools 118 typically analyze a person's voice recordings to capture distinctive speech patterns, tone, accent, and other unique vocal characteristics. By training on this data, the voice cloning tool 118 learns to mimic the speaker's voice. Text-to-speech synthesis is then applied, allowing the system to generate new audio where the cloned voice speaks any given text. Voice cloning tools 118 often use techniques like generative adversarial networks (GANs) and vocoders to enhance the naturalness and accuracy of the cloned voice.

In box 309, the voice cloning detection training service 122 generates synthetic speech audio files 133 using the voice cloning tools 118 and the cloned voice configurations 139. In some cases, the synthetic speech may correspond to the same or different words as compared to the authentic speech. The text of the authentic speech may be used (as preconfigured or determined automatically using a speech-to-text engine), or other text may be used.

In box 312, the voice cloning detection training service 122 analyzes the differences between the authentic speech audio files 130 and the synthetic speech audio files 133 for each respective original voice and corresponding cloned voice. In some scenarios, a first authentic speech audio file 130 used in this comparison may be different from a second authentic speech audio file 130 used to generate the cloned voice configuration 139, but the first and second authentic speech audio files 130 may represent different authentic samples from a same authentic voice or speaker. In various examples, the cloned voices may differ from the authentic voices in terms of pauses, pitch, intonation, consistency, and other attributes. In various embodiments, the voice cloning detection training service 122 may utilize publicly available audio data and/or the voice cloning detection training service 122 may utilize proprietary audio data collected through an audio collection application.

For example, the voice cloning detection training service 122 may utilize an audio-based transformer neural network. An audio-based transformer neural network is a type of deep learning model specifically adapted for processing and understanding audio data, inspired by the Transformer architecture originally developed for Natural Language Processing (NLP). Like in NLP, the Transformer uses self-attention mechanisms to capture relationships between data points across sequences, but in the case of audio, these sequences represent sound waves or features extracted from audio, such as spectrograms.

In this context, the model processes audio signals to capture patterns in time, pitch, and frequency. The self-attention mechanism helps the network understand how different parts of the audio relate to each other, enabling tasks like speech recognition, audio synthesis, and music generation. Transformers can be highly effective for tasks requiring a deep understanding of long-range dependencies in audio, outperforming traditional methods like recurrent neural networks (RNNs) in terms of scalability and parallelization.

In box 315, the voice cloning detection training service 122 trains the voice cloning detection ML models 124 based at least in part on the differences between the authentic speech audio files 130 and the synthetic speech audio files 133. Thereafter, the operation of the portion of the voice cloning detection training service 122 ends.

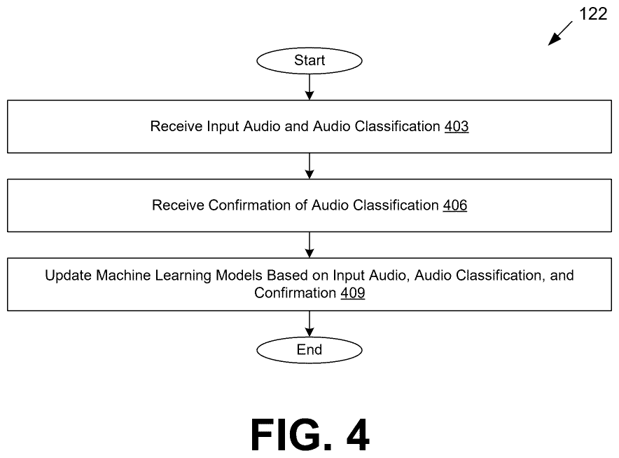

Moving on to FIG. 4, shown is a flowchart that provides one example of the operation of a portion of the voice cloning detection training service 122 according to various embodiments. It is understood that the flowchart of FIG. 4 provides merely an example of the many different types of functional arrangements that may be employed to implement the operation of the portion of the voice cloning detection training service 122 as described herein. As an alternative, the flowchart of FIG. 4 may be viewed as depicting an example of elements of a method implemented in the computing environment 103 (FIG. 1) according to one or more embodiments.

Beginning with box 403, the voice cloning detection training service 122 receives an input audio sample 136 and an audio classification 142 corresponding to the input audio sample 136. The audio classification 142 may be generated through the voice cloning detection service 121 during use of the voice cloning detection service 121.

In box 406, the voice cloning detection training service 122 receives a confirmation of the audio classification 142. For example, a user may confirm that a determination that the input audio sample 136 includes cloned voice is correct, or the user may indicate that the determination is incorrect. Also, the user may confirm that a determination that an input audio sample 136 does not include cloned voice is correct, or the user may indicate that the determination is incorrect.

In box 409, the voice cloning detection training service 122 updates the voice cloning detection ML models 124 based at least in part on the input audio sample 136, the audio classification 142, and the manual confirmation that the audio classification 142 is correct or incorrect. In this way, the manual confirmations of being correct or incorrect allow the voice cloning detection ML models 124 to be improved over time with use to reduce both false cloning determinations or missed cloning determinations. Thereafter, the operation of the portion of the voice cloning detection training service 122 ends.

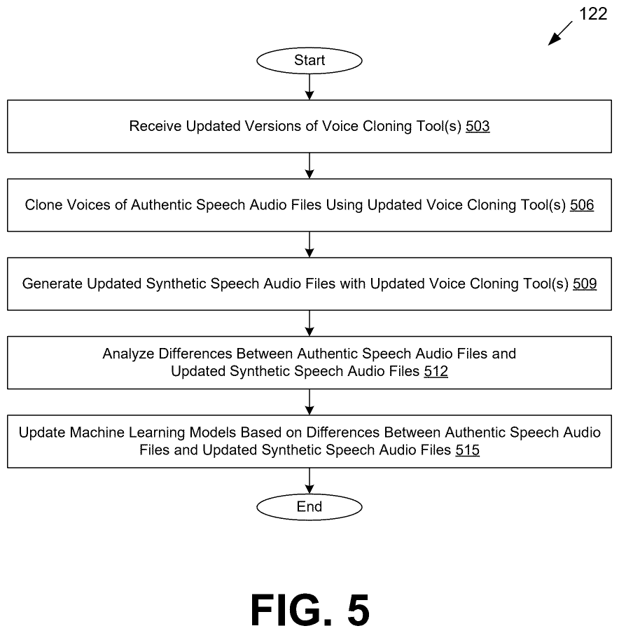

Referring next to FIG. 5, shown is a flowchart that provides one example of the operation of a portion of the voice cloning detection training service 122 according to various embodiments. It is understood that the flowchart of FIG. 5 provides merely an example of the many different types of functional arrangements that may be employed to implement the operation of the portion of the voice cloning detection training service 122 as described herein. As an alternative, the flowchart of FIG. 5 may be viewed as depicting an example of elements of a method implemented in the computing environment 103 (FIG. 1) according to one or more embodiments.

Beginning with box 503, the voice cloning detection training service 122 receives one or more updated versions of the voice cloning tools 118. For example, the developer of a voice cloning tool 118 may release an updated version with improved voice cloning ability. The changes to the voice cloning tool 118 may cause the existing voice cloning detection ML models 124 to become inaccurate for detecting cloned voice generated using the updated voice cloning tool 118.

In box 506, the voice cloning detection training service 122 clones the voices represented in the authentic speech audio files 130 using the updated voice cloning tools 118, thereby generating one or more updated cloned voice configurations 139. In some cases, multiple voice cloning tools 118 may be used for each of the authentic speech audio files 130 to generate multiple instances of the cloned voice configurations 139.

In box 509, the voice cloning detection training service 122 generates updated synthetic speech audio files 133 using the updated voice cloning tools 118 and the updated cloned voice configurations 139. In some cases, the synthetic speech may correspond to the same or different words as compared to the authentic speech. The text of the authentic speech may be used (as preconfigured or determined automatically using a speech-to-text engine), or other text may be used.

In box 512, the voice cloning detection training service 122 analyzes the differences between the authentic speech audio files 130 and the updated synthetic speech audio files 133 for each respective original voice and corresponding cloned voice.

In box 515, the voice cloning detection training service 122 updates the voice cloning detection ML models 124 based at least in part on the differences between the authentic speech audio files 130 and the updated synthetic speech audio files 133. In this way, the voice cloning detection ML models 124 are trained to accurately detect cloned voice generated by use of the updated voice cloning tools 118. Thereafter, the operation of the portion of the voice cloning detection training service 122 ends.

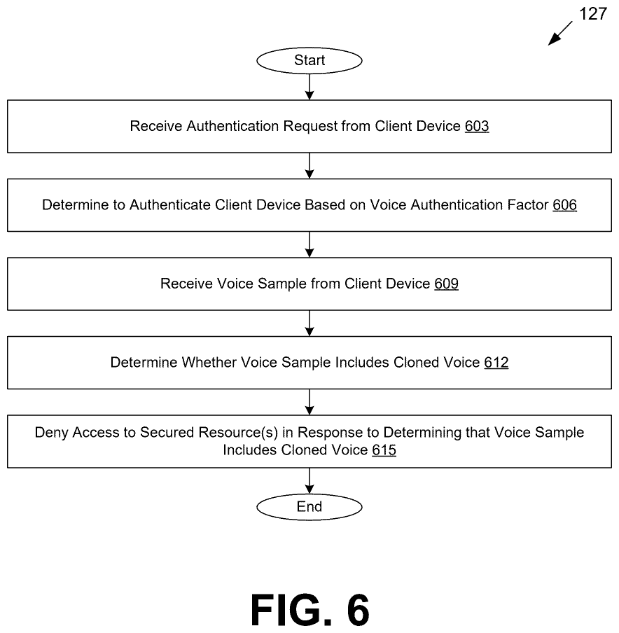

Turning now to FIG. 6, shown is a flowchart that provides one example of the operation of a portion of the authentication service 127 according to various embodiments. It is understood that the flowchart of FIG. 6 provides merely an example of the many different types of functional arrangements that may be employed to implement the operation of the portion of the authentication service 127 as described herein. As an alternative, the flowchart of FIG. 2 may be viewed as depicting an example of elements of a method implemented in the computing environment 103 (FIG. 1) according to one or more embodiments.

Beginning with box 603, the authentication service 127 receives an authentication request from a client device, such as the audio source device 106. For example, the client device may be requesting access to one or more secured resources 145 in the data store 112 that require authentication and appropriate permissions to access.

In box 606, the authentication service 127 may determine to authenticate the client device based at least in part on a voice authentication factor. For example, the authentication service 127 may ask the user to speak a word or sentence, thereby generating an audio sample. The audio sample can then be analyzed to see if it matches the characteristics of the authentic user's voice. Other authentication factors, such as, for example, passwords, keys, tokens, one-time codes, fingerprints, etc., may be utilized in addition to the voice authentication factor. However, the voice authentication factor may be susceptible to voice cloning attacks, when an attacker can gain access to an audio sample of the user and then use a voice cloning tool 118 to create cloned voice of the user from the audio sample.

In box 609, the authentication service 127 receives a voice sample from the client device. In box 612, the authentication service 127 uses the voice cloning detection service 121 to determine whether the voice sample includes a cloned voice. If the voice sample includes a cloned voice, in box 615, the authentication service 127 fails the authentication request, thereby denying the client device access to the secured resources 145. Thereafter, the operation of the authentication service 127 ends.

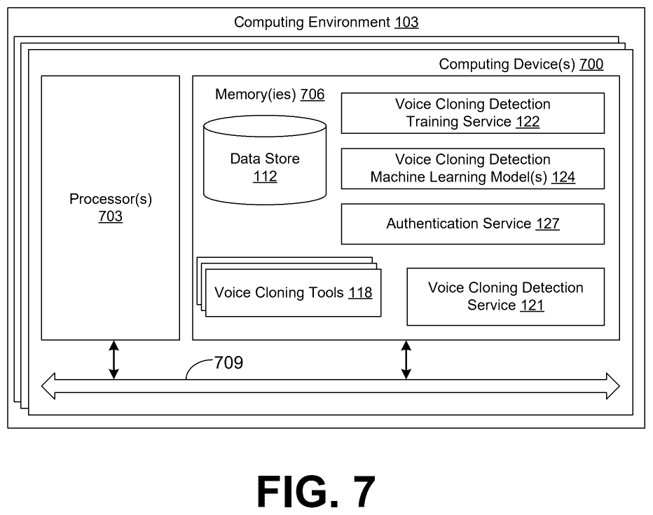

With reference to FIG. 7, shown is a schematic block diagram of the computing environment 103 according to an embodiment of the present disclosure. The computing environment 103 includes one or more computing devices 700. Each computing device 700 includes at least one processor circuit, for example, having a processor 703 and a memory 706, both of which are coupled to a local interface 709. To this end, each computing device 700 may comprise, for example, at least one server computer or like device. The local interface 709 may comprise, for example, a data bus with an accompanying address/control bus or other bus structure as can be appreciated.

Stored in the memory 706 are both data and several components that are executable by the processor 703. In particular, stored in the memory 706 and executable by the processor 703 are the voice cloning tools 118, the voice cloning detection service 121, the voice cloning detection training service 122, the voice cloning detection ML model 124, the authentication service 127, and potentially other applications. Also stored in the memory 706 may be a data store 112 and other data. In addition, an operating system may be stored in the memory 706 and executable by the processor 703.

It is understood that there may be other applications that are stored in the memory 706 and are executable by the processor 703 as can be appreciated. Where any component discussed herein is implemented in the form of software, any one of a number of programming languages may be employed such as, for example, C, C++, C #, Objective C, Java®, JavaScript®, Perl, PHP, Visual Basic®, Python®, Ruby, Flash®, or other programming languages.

A number of software components are stored in the memory 706 and are executable by the processor 703. In this respect, the term “executable” means a program file that is in a form that can ultimately be run by the processor 703. Examples of executable programs may be, for example, a compiled program that can be translated into machine code in a format that can be loaded into a random access portion of the memory 706 and run by the processor 703, source code that may be expressed in proper format such as object code that is capable of being loaded into a random access portion of the memory 706 and executed by the processor 703, or source code that may be interpreted by another executable program to generate instructions in a random access portion of the memory 706 to be executed by the processor 703, etc. An executable program may be stored in any portion or component of the memory 706 including, for example, random access memory (RAM), read-only memory (ROM), hard drive, solid-state drive, universal serial bus (USB) flash drive, memory card, optical disc such as compact disc (CD) or digital versatile disc (DVD), floppy disk, magnetic tape, or other memory components.

The memory 706 is defined herein as including both volatile and nonvolatile memory and data storage components. Volatile components are those that do not retain data values upon loss of power. Nonvolatile components are those that retain data upon a loss of power. Thus, the memory 706 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 703 may represent multiple processors 703 and/or multiple processor cores and the memory 706 may represent multiple memories 706 that operate in parallel processing circuits, respectively. In such a case, the local interface 709 may be an appropriate network that facilitates communication between any two of the multiple processors 703, between any processor 703 and any of the memories 706, or between any two of the memories 706, etc. The local interface 709 may comprise additional systems designed to coordinate this communication, including, for example, performing load balancing. The processor 703 may be of electrical or of some other available construction.

Although the voice cloning tools 118, the voice cloning detection service 121, the voice cloning detection training service 122, the voice cloning detection ML model 124, the authentication service 127, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 2-6 show the functionality and operation of an implementation of portions of the voice cloning detection service 121, the voice cloning detection training service 122, and the authentication service 127. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 703 in a computer system or other system. The machine code may be converted from the source code, etc. If embodied in hardware, each block may represent a circuit or a number of interconnected circuits to implement the specified logical function(s).

Although the flowcharts of FIGS. 2-6 show a specific order of execution, it is understood that the order of execution may differ from that which is depicted. For example, the order of execution of two or more blocks may be scrambled relative to the order shown. Also, two or more blocks shown in succession in FIGS. 2-6 may be executed concurrently or with partial concurrence. Further, in some embodiments, one or more of the blocks shown in FIGS. 2-6 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the voice cloning tools 118, the voice cloning detection service 121, the voice cloning detection training service 122, the voice cloning detection ML model 124, and the authentication service 127, that comprises software or code can be embodied in any non-transitory computer-readable medium for use by or in connection with an instruction execution system such as, for example, a processor 703 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the voice cloning tools 118, the voice cloning detection service 121, the voice cloning detection training service 122, the voice cloning detection ML model 124, and the authentication service 127, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 700, or in multiple computing devices 700 in the same computing environment 103.

Unless otherwise explicitly stated, articles such as “a” or “an”, and the term “set”, should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. A computer-implemented method, comprising:
receiving an audio sample of a voice;
determining whether the voice in the audio sample is an authentic voice or a cloned voice by analyzing the audio sample using a machine learning model trained to recognize cloned voices generated by voice cloning tools that electronically generate speech from identified speech characteristics in reference samples; and
implementing an action in response to determining that the voice is the cloned voice, implementing the action further comprising at least one of:
causing a graphical user interface on a phone device to render a notification indicating detection of the cloned voice;
returning an indication via an application programming interface that the voice is determined to be cloned; or
denying a request to access a secured resource using the voice as an authentication factor.

2. The computer-implemented method of claim 1, further comprising training the machine learning model based at least in part on cloned voices generated by a plurality of different voice cloning tools.

3. The computer-implemented method of claim 1, further comprising training the machine learning model to recognize a difference between an authentic voice sample and a cloned voice sample generated by a voice cloning tool using at least a portion of the authentic voice sample.

4. The computer-implemented method of claim 1, further comprising training the machine learning model based at least in part on a first authentic voice sample and a cloned voice sample generated by a voice cloning tool using a second authentic voice sample, wherein the first and second authentic voice samples embody a same authentic voice but are different samples.

5. The computer-implemented method of claim 1, wherein determining whether the voice in the audio sample is the authentic voice or the cloned voice further comprises assigning a confidence score corresponding to a likelihood that the voice is the cloned voice.

6. The computer-implemented method of claim 1, further comprising capturing the audio sample from a caller in an ongoing call to the phone device.

7. The computer-implemented method of claim 1, wherein implementing the action in response to determining that the voice is the cloned voice further comprises denying the request to access the secured resource using the voice as the authentication factor.

8. The computer-implemented method of claim 1, wherein the machine learning model comprises a neural network transformer.

9. The computer-implemented method of claim 1, wherein determining whether the voice in the audio sample is the authentic voice or the cloned voice is based at least in part on speech content from the audio sample generated from a speech-to-text tool.

10. The computer-implemented method of claim 9, wherein determining whether the voice in the audio sample is the authentic voice or the cloned voice is further based at least in part on determining whether the speech content is associated with a malicious intent.

11. A system, comprising:
at least one computing device; and
instructions executable by the at least one computing device that cause the at least one computing device to at least:
receive an audio sample of a voice;
determine whether the voice in the audio sample is an authentic voice or a cloned voice using a machine learning model trained to recognize cloned voices; and
implement an action in response to determining that the voice is the cloned voice.

12. The system of claim 11, wherein an architecture of the machine learning model is specially adapted to a voice authentication detection task.

13. The system of claim 11, wherein the instructions further cause the at least one computing device to at least train the machine learning model based at least in part on an authentic voice sample and a cloned voice sample generated by a voice cloning tool using at least a portion of the authentic voice sample.

14. The system of claim 11, wherein the instructions further cause the at least one computing device to at least train the machine learning model based at least in part on a first authentic voice sample and a cloned voice sample generated by a voice cloning tool using a second authentic voice sample, wherein the first and second authentic voice samples embody a same authentic voice but are different samples.

15. The system of claim 11, wherein the instructions further cause the at least one computing device to at least assign a confidence score corresponding to a likelihood that the voice is the cloned voice.

16. The system of claim 11, wherein the instructions further cause the at least one computing device to at least cause a notification to be transmitted to a phone device, wherein the audio sample is captured from a caller in an ongoing call to the phone device.

17. The system of claim 11, wherein the instructions further cause the at least one computing device to at least deny a request to access a secured resource using the voice as an authentication factor.

18. The system of claim 11, wherein the machine learning model comprises a neural network transformer.

19. A non-transitory computer-readable medium storing instructions that when executed cause at least one computing device to at least:
train a machine learning model to determine whether audio is authentic voice or generated by a voice cloning tool;
receive an audio sample of a voice captured from a call;
determine whether the voice in the audio sample is an authentic voice or a cloned voice using the machine learning model; and
send a notification to a phone device on the call in response to determining that the voice is the cloned voice.

20. The non-transitory computer-readable medium of claim 19, wherein determining whether the voice in the audio sample is the authentic voice or the cloned voice is based at least in part on determining whether the audio sample is associated with a malicious intent.
